(19) United States
(12) Patent Application Publication
(10) Pub. No.: US 2026/0003300 A1
(43) Pub. Date: Jan. 1, 2026

(54) IMAGE FORMING APPARATUS, CONTROL METHOD, AND RECORDING MEDIUM STORING CONTROL PROGRAM

(71) Applicant: KONICA MINOLTA, INC., Tokyo (JP)

(72) Inventors: Mikihiko TAKADA, Tokyo (JP); Shunichi TAKAYA, tokyo (JP); Toshiki HAYAMI, Tokyo (JP); Hiromu ASO, Tokyo (JP); Masayuki KADOGUCHI, Tokyo (JP)

(21) Appl. No.: 19/226,694

(22) Filed: Jun. 3, 2025

(30) Foreign Application Priority Data
Jun. 26, 2024 (JP) 2024-102824

(51) Int. Cl. G03G 15/01; G03G 9/08; G03G 15/041; G03G 15/06; G03G 15/16

(52) U.S. Cl. CPC G03G 15/0121; G03G 9/0819; G03G 9/0827; G03G 15/011; G03G 15/0126; G03G 15/0131; G03G 15/0189; G03G 15/0415; G03G 15/065; G03G 15/1675; G03G 2215/0604

(57) ABSTRACT

An image forming apparatus that forms a toner image by superimposing toner layers on an intermediate transfer member and transfers the formed toner image onto a recording medium, the image forming apparatus including a hardware processor that performs specific control for reducing, relative to a volume of a single-layer toner image to be transferred onto the recording medium when the single-layer toner image including a single-color toner layer is formed, a volume of a lowermost toner layer with a color same as a color of the single-color toner layer in a multilayer toner image to be transferred onto the recording medium when the multilayer toner image is formed by superimposing toner layers of a plurality of colors having a pattern same as a pattern of the single-layer toner image.

### CROSS-REFERENCE TO RELATED APPLICATION

Japanese patent application No. 2024-102824 filed on Jun. 26, 2024, including description, claims, drawings, and abstract the entire disclosure is incorporated herein by reference in its entirety.

### BACKGROUND OF THE INVENTION

### 1. Technical Field

The present invention relates to an image forming apparatus, a control method, and a recording medium storing a control program.

### 2. Description of Related Art

An image forming apparatus using an electrophotographic method, for example, develops an electrostatic latent image formed by exposing a charged photoreceptor with toner to form a toner image on the surface of the photoreceptor, transfers the toner image to an intermediate transfer member, and then transfers the toner image to a recording medium from the intermediate transfer member. Thereafter, the image forming apparatus performs fixing processing for heating and pressurizing the toner image on the recording medium to fix the toner image on the recording medium, thereby forming an image on the recording medium.

A phenomenon is known in which toner of the toner image scatters outside a region where the toner image is to be originally formed during, for example, the formation of the toner image on the recording medium.

The following prior art is disclosed in Japanese Unexamined Patent Application Publication No. 2012-203298. The edge of an object constituting an image formed by sequentially transferring toner images on a recording medium using toner of a plurality of colors is detected. At the edge, a first toner layer that is formed using toner of one color among toners of a plurality of colors and that is to be transferred first to a recording medium is widened by an amount corresponding to a specific pixel so that the area of the first toner layer is larger than the area of a second toner layer that is formed using toner of another color and that is to be transferred second or later. Thus, even when the toner of the second toner layer scatters from the upper part of the toner of the first toner layer, the toner of the widened part of the first toner layer receives the toner of the second toner layer, so that the scattering of the toner from the image can be prevented.

### SUMMARY OF THE INVENTION

However, in a case where an image such as a character or a line image is formed by superimposing, on white toner of the lowermost layer, toner of another color having the same pattern as the white toner, the white toner may scatter to the outside of the pattern. In this case, the white toner scattering to the outside of the pattern falls outside the pattern of the toner of the other color, and thus an unintended image edged with white is formed. This is more remarkably visually recognized when the image is formed on a transparent film or the like. The above-mentioned prior art does not consider the scattering of toner of the lowermost layer, and thus cannot address the above-mentioned problem.

The present invention has been made to solve such a problem. That is, an object of the present invention is to provide an image forming apparatus, a control method, and a control program with which it is possible to reduce an influence on an image to be formed due to scattering of toner of a lowermost toner layer of a multilayer toner image to be transferred onto a recording medium.

To achieve at least one of the abovementioned objects, according to an aspect of the present invention, an image forming apparatus reflecting one aspect of the present invention comprises the followings.

An image forming apparatus that forms a toner image by superimposing toner layers on an intermediate transfer member and transfers the formed toner image onto a recording medium, the image forming apparatus including a hardware processor that performs specific control for reducing, relative to a volume of a single-layer toner image to be transferred onto the recording medium when the single-layer toner image including a single-color toner layer is formed, a volume of a lowermost toner layer with a color same as a color of the single-color toner layer in a multilayer toner image to be transferred onto the recording medium when the multilayer toner image is formed by superimposing toner layers of a plurality of colors having a pattern same as a pattern of the single-layer toner image.

### BRIEF DESCRIPTION OF THE DRAWINGS

The advantages and features provided by one or more embodiments of the present invention will be more fully understood from the following detailed description and the accompanying drawings. It is to be noted that these are for purposes of illustration only and are not intended to limit the present invention.

FIG. 1 is a schematic diagram illustrating the configuration of an image forming apparatus;

FIG. 2 is a block diagram illustrating the configuration of the image forming apparatus;

FIG. 3 is an explanatory diagram illustrating a toner layer formed on each photosensitive drum;

FIG. 4 is a configuration diagram of a main part of an image forming unit;

FIG. 5 is a photograph of a comparative example in which a specific multilayer toner image is formed on a tack sheet;

FIG. 6 is an explanatory diagram illustrating a state in which toner of the lowermost toner layer scatters during primary transfer;

FIG. 7 is an explanatory diagram illustrating a state in which toner of the lowermost toner layer scatters during secondary transfer;

FIG. 8 is an explanatory diagram illustrating states of toner layers of the respective colors on photosensitive drums before the primary transfer in order to compare a comparative example in which specific control is not performed and the present embodiment in which the specific control is performed;

FIG. 9 is an explanatory diagram illustrating states of toner layers of the respective colors on a film after the secondary transfer in order to compare the comparative example in which the specific control is not performed and the present embodiment in which the specific control is performed;

FIG. 10 is an explanatory diagram illustrating a multilayer toner image other than the specific multilayer toner image;

FIG. 11 is an explanatory diagram illustrating a specific multilayer toner image;

FIG. 12 is a diagram illustrating, for comparison, a photograph of a comparative example in which a specific multilayer toner image is formed on a tack sheet without the specific control and a photograph of an example in which the specific multilayer toner image is formed on a tack sheet with the specific control;

FIG. 13 is a diagram illustrating, for comparison, a photograph of a comparative example in which a specific multilayer toner image is formed on a foil sheet without the specific control and a photograph of an example in which the specific multilayer toner image is formed on a foil sheet with the specific control;

FIG. 14 is a flowchart illustrating an operation of the image forming apparatus;

FIG. 15 is an explanatory diagram illustrating states of toner layers of the respective colors on photosensitive drums before the primary transfer in order to compare a comparative example in which specific control is not performed and the present embodiment in which the specific control is performed;

FIG. 16 is an explanatory diagram illustrating states of toner layers of the respective colors on a film after the secondary transfer in order to compare the comparative example in which the specific control is not performed and the present embodiment in which the specific control is performed;

FIG. 17 is an explanatory diagram illustrating states of toner layers of the respective colors on photosensitive drums before the primary transfer in order to compare a comparative example in which specific control is not performed and the present embodiment in which the specific control is performed; and

FIG. 18 is an explanatory diagram illustrating states of toner layers of the respective colors on a film after the secondary transfer in order to compare the comparative example in which the specific control is not performed and the present embodiment in which the specific control is performed.

### DETAILED DESCRIPTION

An image forming apparatus, a control method, and a recording medium storing a control program according to embodiments of the present invention will be described below with reference to the accompanying drawings. It is to be noted that the scope of the present invention is not limited to the disclosed embodiments. In the drawings, the same components are denoted by the same reference signs, and redundant description is omitted. In addition, dimensional ratios in the drawings are exaggerated for convenience of description and may be different from actual ratios.

### First Embodiment

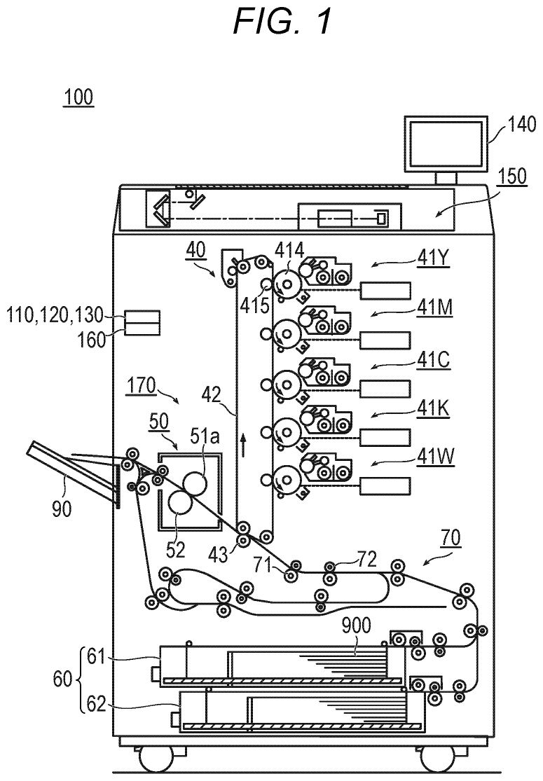

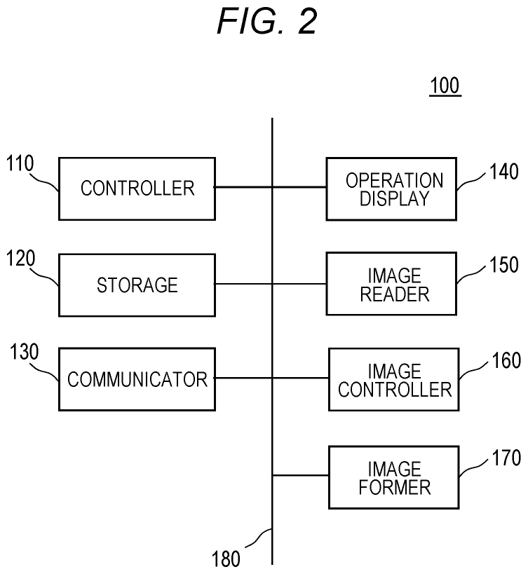

FIG. 1 is a schematic diagram illustrating the configuration of an image forming apparatus 100. FIG. 2 is a block diagram illustrating the configuration of the image forming apparatus 100.

The image forming apparatus 100 includes a controller 110, a storage 120, a communicator 130, an operation display 140, an image reader 150, an image controller 160, and an image former 170. These constituent elements are communicatively connected to each other via a bus 180. The image forming apparatus 100 may be implemented by a multifunction peripheral (MFP). The controller 110 and the image controller 160 constitute a controller. The controller 110, the storage 120, the operation display 140, and the image controller 160 constitute a computer.

The controller 110 includes a central processing unit (CPU) and various memories, and performs control of the above-described elements and various types of arithmetic processing in accordance with a program. The operation of the controller 110 will be described later.

The storage 120 includes a solid state drive (SDD) or a hard disc drive (HDD), and stores various programs and various types of data.

The communicator 130 is an interface for enabling communication between the image forming apparatus 100 and an external device. As the communicator 130, a network interface compliant with a standard such as Ethernet (registered trademark), SATA, or IEEE1394 is used. As the communicator 130, various kinds of local connection interfaces including wireless communication interfaces such as Bluetooth (registered trademark) and IEEE802.11 may be used.

The operation display 140 includes a touch screen, a numeric keypad, a start button, a stop button, and the like, and is used for displaying various kinds of information and inputting various instructions.

The image reader 150 includes a light source such as a fluorescent lamp and an imaging element such as a charge coupled device (CCD) image sensor. The image reader 150 irradiates a document set at a predetermined reading position with light from the light source, photoelectrically converts the reflected light with the imaging element, and generates image data from the electrical signal.

The image controller 160 performs layout and rasterization of print data included in a print job or the like received from the communicator 130, and generates image data in a bitmap format. The image data is output to the image former 170, which will be described later, as an image signal used for exposure by the image former 170. The image signal corresponds to the image data and the image data is generated based on the print data. Therefore, it can be said that the image signal is generated based on the print data. The image controller 160 constitutes an image signal generator.

The print job is a generic term for a printing instruction to be given to the image forming apparatus 100, and includes print data and print setting. The print data is data about a document to be printed, and the print data can include various kinds of data such as image data, vector data, and text data. Specifically, the print data may be page description language (PDL) data, portable document format (PDF) data, or tagged image file format (TIFF) data. The print setting is a setting related to image formation on a recording medium, and includes various settings such as the number of pages, the number of printed copies, the type of recording medium, selection of color or monochrome, double-sided printing, and page layout.

The recording medium includes a film, a tack sheet, a foil sheet, a sheet, a container, and the like. In order to simplify the description, a case where the recording medium is a film 900 will be described as an example.

The image former 170 includes an image forming section 40, a fixer 50, a sheet feeder 60, and a sheet conveyor 70. The sheet conveyor 70 forms a conveyance path for conveying the film 900 by a plurality of conveyance rollers 72. The image forming section 40 constitutes a toner image former.

The image forming section 40 includes image forming units 41 (41Y, 41M, 41C, and 41K) corresponding to toners of respective colors of yellow (Y), magenta (M), cyan (C), and black (K). The image forming section 40 may further include an image forming unit 41W corresponding to toner of white (W) which is a spot color. In the following, the letters Y, M, C, K, and W are added to the image forming units 41 and the elements included in the image forming units 41 only when the image forming units 41 and the elements included in the image forming units 41 are distinguished from each other. The image forming unit 41 includes a developing device 411, an optical writer 413, a charger 412, a photosensitive drum 414, and a primary transfer roller 415. The photosensitive drum 414 forms a photoreceptor. The developing device 411, the optical writer 413, the charger 412, and the photosensitive drum 414 may be provided so as to be replaceable as a set. Each of the image forming units 41 performs charging, exposure, and developing processes to form a toner layer 500 on the photosensitive drum 414 on the basis of image data. The toner layer 500 formed on each photosensitive drum 414 is a pattern of toner 501 of a single color.

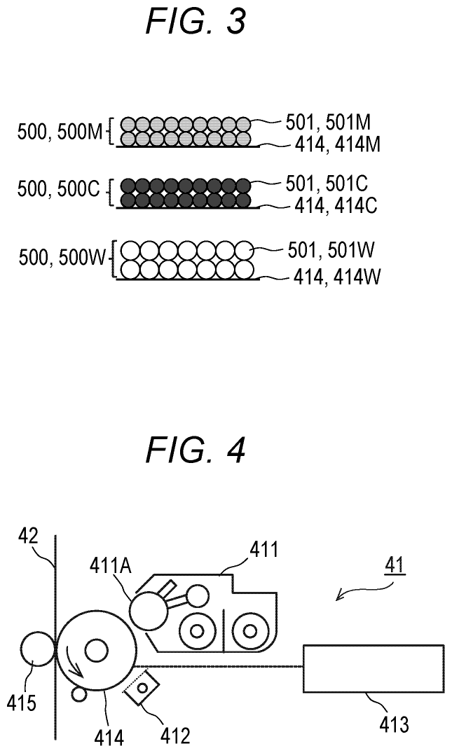

FIG. 3 is an explanatory diagram illustrating the toner layer 500 formed on each photosensitive drum 414.

In the example illustrated in FIG. 3, toner layers 500M, 500C, and 500W of three colors of magenta (M), cyan (C), and white (W) are formed on the photosensitive drums 414M, 414C, and 414 W, respectively.

The toner layers 500 formed on the photosensitive drums 414 are sequentially superimposed and primarily transferred onto an intermediate transfer belt 42 by an electrostatic force generated by a primary transfer voltage that is applied to the primary transfer roller 415. Thus, a color toner image 510 (see FIG. 6) is retained on the intermediate transfer belt 42. The color toner image on the intermediate transfer belt 42 is secondarily transferred onto the film 900 by a secondary transfer roller 43. The intermediate transfer belt 42 constitutes an intermediate transfer member.

The image forming unit 41 will be described in more detail.

FIG. 4 is a configuration diagram of a main part of the image forming unit 41. An arrow in FIG. 4 indicates a rotation direction of the photosensitive drum 414.

The charger 412 applies a high voltage to a charging wire to cause corona discharge, thereby charging the surface of the photosensitive drum 414. The charging potential of the photosensitive drum 414 is controlled by applying a voltage to a charging grid. The optical writer 413 performs exposure by forming an electrostatic latent image on the photosensitive drum 414 by scanning exposure using a laser diode. More specifically, the optical writer 413 performs exposure by forming an electrostatic latent image on the photosensitive drum 414 by scanning exposure using a laser diode that is driven on the basis of an image signal. The optical writer 413 constitutes a writing section. The light amount of the laser at the time of scanning exposure by the laser diode can be adjusted as follows each time the image forming apparatus 100 is started up. A halftone patch and a solid patch are formed on the intermediate transfer belt 42, and the image density of each patch is read and detected by an IDC sensor. Next, the light amount of the laser is adjusted so that the halftone patch and the solid patch have predetermined image densities, respectively.

In the developing device 411, a developer including toner and magnetic carriers is held and conveyed on the surface of a developing sleeve 411A containing a magnetic material. A developing voltage is applied to the developing sleeve 411A while the developing sleeve 411A is rotated, and the toner in the developer conveyed to the developing sleeve 411A is transferred to the latent image on the photosensitive drum 414, so that the latent image is developed as an image of the toner layer 500. The developing device 411 constitutes a developing section. The developing voltage can be adjusted as follows each time the image forming apparatus 100 is started up. A halftone patch and a solid patch are formed on the intermediate transfer belt 42, and the image density of each patch is read and detected by an IDC sensor. Next, the developing voltage is adjusted so that the halftone patch and the solid patch have predetermined image densities, respectively.

The photosensitive drum 414 of each image forming unit 41 is pressed against and brought into contact with the primary transfer roller 415 with the intermediate transfer belt 42 therebetween. Thus, the photosensitive drum 414 is brought into contact with the intermediate transfer belt 42. For example, by moving the primary transfer roller 415, the photosensitive drum 414 and the primary transfer roller 415 can be brought into contact with or separated from each other with the intermediate transfer belt 42 therebetween. A primary transfer bias is applied to the primary transfer roller 415. When the primary transfer bias is applied to the primary transfer roller 415 while the photosensitive drum 414 is in contact with the intermediate transfer belt 42, the toner image is transferred from the photosensitive drum 414 to the intermediate transfer belt 42 by an electrostatic force from the primary transfer roller 415.

The photosensitive drum 414 is an image bearing member including a hollow cylindrical main body (base) and a photosensitive layer, and rotates at a predetermined speed. The main body (base) is made of, for example, metal such as aluminum. The photosensitive layer is formed of, for example, a resin such as polycarbonate containing an organic photoconductor (OPC).

As the intermediate transfer belt 42, a semiconductive endless (seamless) resinous belt having a volume resistivity of about 1.0×10⁷ to 1.0×10⁹ Ω·cm and a surface resistivity of about 1.0×10¹⁰ to 1.0×10¹² Ω/sq. is used. As the resinous belt, it is possible to use a 0.05-0.5 mm thick semiconductive resinous film obtained by dispersing conductive materials in engineering plastics such as modified polyimide, thermosetting polyimide, ethylene-tetrafluorocthylene copolymer, and polyvinylidene fluoride. As the intermediate transfer belt 42, it is also possible to use a 0.5-2.0 mm thick semiconductive rubber belt obtained by dispersing conductive materials in silicone rubber, urethane rubber, or the like. The intermediate transfer belt 42 is looped around a plurality of roller members including a tension roller 36 and the like, and is supported so as to be rotatable in a vertical direction.

The primary transfer roller 415 is formed of a roller-shaped conductive member using, for example, a metal shaft and foamed rubber such as silicone or urethane covering the periphery thereof. The primary transfer rollers 415 are disposed to face the photosensitive drums 414 for the respective colors with the intermediate transfer belt 42 interposed therebetween, and press the back surface of the intermediate transfer belt 42 to form transfer regions between the primary transfer rollers 415 and the photosensitive drums 414. A primary transfer voltage having a polarity opposite to that of the toner is applied to the primary transfer roller 415 by constant voltage control, and the toner image on the photosensitive drum 414 is primarily transferred onto the intermediate transfer belt 42 by an electrostatic force of a transfer electric field formed in the transfer region. The primary transfer voltage is set in advance so that the transfer efficiency for transferring the toner layer of each color from the photosensitive drum 414 to the intermediate transfer belt 42 is maximized, every time the image forming apparatus 100 is started up, for example. The primary transfer roller 415 constitutes a primary transferer. The primary transfer voltage forms a primary transfer bias.

The secondary transfer roller 43 is pressed against the intermediate transfer belt 42 with the film 900 interposed therebetween. Thus, the secondary transfer roller 43 is brought into contact with the intermediate transfer belt 42 with the film 900 therebetween. A secondary transfer voltage is applied to the secondary transfer roller 43. When the secondary transfer voltage is applied to the secondary transfer roller 43 with the secondary transfer roller 43 being in contact with the intermediate transfer belt 42 with the film 900 therebetween, the toner image is secondarily transferred from the intermediate transfer belt 42 to the film 900 by an electrostatic force from the secondary transfer roller 43. The secondary transfer voltage is set in advance depending on the type of the recording medium so that the transfer efficiency for transferring the toner image from the intermediate transfer belt 42 to the film 900 is optimized, every time the image forming apparatus 100 is started up, for example. Specifically, the secondary transfer voltage is set in advance so that the transfer efficiency is optimized in consideration of various toner images 510 such as a single-layer toner image 510 in a single color, a multilayer toner image 510 in two or three colors, a solid toner image 510, and a toner image 510 in each tone. The secondary transfer roller 43 constitutes a secondary transferer.

The secondary transfer voltage forms a secondary transfer bias.

The fixer 50 includes a fixing roller 51a and a pressure roller 52, and the fixing roller 51a and the pressure roller 52 are pressed against each other to form a nip between the fixing roller 51a and the pressure roller 52. The fixer 50 heats and pressurizes, at the nip, the film 900 conveyed to the nip, and rotates the fixing roller 51a and the pressure roller 52, thereby heating and fixing the toner image 510 on the film 900 to the front side of the film 900.

The film 900 on which the toner image 510 has been heated and fixed is ejected to a sheet ejection tray 90 by the conveyance rollers 72.

When double-sided printing is set in the print setting of the print job, the sheet conveyor 70 conveys the film 900 having the toner image 510 heated and fixed on its front side to an auto duplex unit (ADU) conveyance path 80. The film 900 conveyed to the ADU conveyance path 80 is turned upside down by a switchback path and then conveyed to the conveyance path 71, and an image is again formed on the back side of the sheet by the image former 170.

The operation of the controller 110 will be described later.

The controller 110 performs specific control for reducing the volume of the lowermost toner layer 500 of a multilayer toner image 510 to be transferred onto the film 900 when the multilayer toner image 510 is formed by superimposing the toner layers 500 of a plurality of colors of the same pattern by the image former 170. In the following, the lowermost toner layer 500 of the multilayer toner image 510 is simply referred to as “lowermost toner layer”. A single-layer toner image that includes a single-color toner layer 500 and that is to be transferred onto the film 900 when the single-layer toner image 510 is formed is simply referred to as “single-layer toner image”. A single toner layer 500 forming the single-layer toner image is also simply referred to as “single toner layer”. The specific control is performed for reducing the volume of the lowermost toner layer, which has a color same as that of the single toner layer, of a multilayer toner image 510 to be transferred onto the film 900 when the multilayer toner image 510 is formed by superimposing the toner layers 500 of a plurality of colors of the same pattern as the single-layer toner image. When the multilayer toner image 510 is formed by superimposing the toner layers 500 of a plurality of colors having the same pattern, the multilayer toner image 510 formed by superimposing the toner layers 500 is also simply referred to as “specific multilayer toner image”.

In the present embodiment, the specific control is performed by causing the image controller 160 to generate an image signal in which the area of the lowermost toner layer of the specific multilayer toner image to be transferred onto the film 900 is reduced by a predetermined number of pixels relative to the area of the upper toner layer 500. Specifically, the image former 170 reduces the area of the lowermost toner layer of the specific multilayer toner image by a predetermined number of pixels relative to the area of the upper toner layer 500 in the image data of each color obtained by rasterizing the print data. Then, the image former 170 generates an image signal of image data obtained by reducing the area of the lowermost toner layer of the specific multilayer toner image by a predetermined number of pixels. In the specific control, the area of the lowermost toner layer can be reduced by a predetermined number of pixels by, for example, moving the contour line of the pattern of the lowermost toner layer inward by the same number of pixels relative to the pattern of the upper layer. The predetermined number of pixels can be set to an appropriate value by an experiment from the viewpoint of an influence on the image to be formed on the film 900 due to the scattering of the toner 501, a change in color of the image to be formed on the film 900, and the like.

Due to the specific control, the influence on the image to be formed due to the scattering of the toner 501 of the lowermost toner layer can be reduced. A mechanism for reducing the influence on the image to be formed due to the scattering of the toner 501 of the lowermost toner layer by the specific control will be described below.

### (Influence on Image Due to Scattering of Toner of Lowermost Toner Layer)

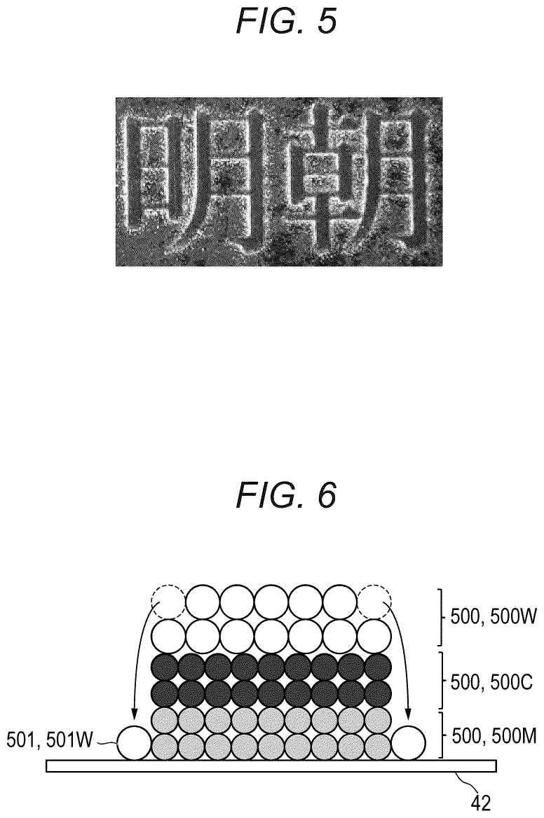

FIG. 5 is a photograph of a comparative example in which a specific multilayer toner image is formed on a tack sheet. In the comparative example of FIG. 5, a tack sheet that has a surface base material formed of transparent polypropylene (PP) and a release paper formed of transparent polyethylene terephthalate (PET) is used as the recording medium. The lowermost toner image of the specific multilayer toner image is formed with white (W) toner 501, and the toner layer 500 with cyan (C) toner 501 having the same pattern as the lowermost toner image is superimposed on the lowermost toner image. Note that the photograph illustrated in FIG. 5 is captured with black paper laid on the back of the tack sheet.

As illustrated in FIG. 5, the white (W) toner 501 of the lowermost toner image scatters to the outside of the pattern, so that the white (W) toner 501 falls outside the pattern of the upper toner layer 500 formed of the cyan (C) toner 501. Thus, an image in which the pattern of the cyan (C) toner layer 500 is edged with white (W) is formed.

### (Mechanism of Occurrence of Scattering of Toner of Lowermost Toner Layer)

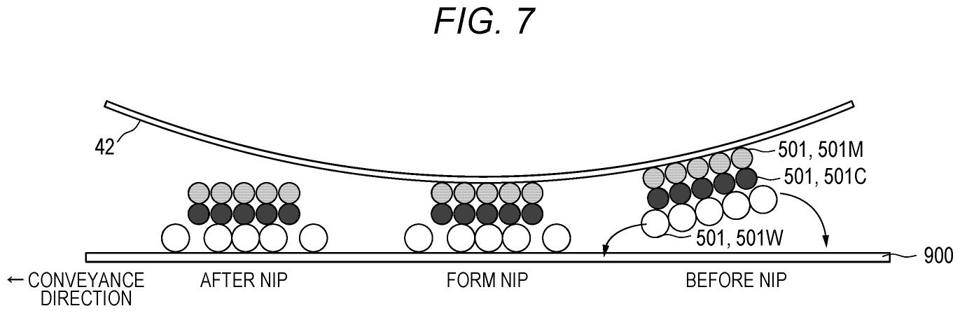

FIG. 6 is an explanatory diagram illustrating a state in which toner 501 of the lowermost toner layer scatters during primary transfer. FIG. 7 is an explanatory diagram illustrating a state in which toner 501 of the lowermost toner layer scatters during secondary transfer.

As illustrated in FIG. 6, the toner 501 of the lowermost toner layer may scatter during the primary transfer. This is considered to be caused because the adhesive force between toner particles of the toner 501 of the lowermost toner layer is relatively weak due to electrostatic force from the primary transfer roller 415, and thus, the end portions of the toner 501 of the lowermost toner layer are attracted. The scattered toner 501 adheres to the intermediate transfer belt 42 outside the pattern of the toner layer 500. As a result, the scattered toner 501 is secondarily transferred to the film 900 together with the specific multilayer toner image, thereby affecting the image to be formed on the film 900.

As illustrated in FIG. 7, the toner 501 of the lowermost toner layer may scatter during the secondary transfer. The reason for this is considered as follows. During the secondary transfer, the toner 501 of the lowermost toner layer on the intermediate transfer belt 42 is attracted by the electrostatic force from the secondary transfer roller 43 immediately before the specific multilayer toner image is conveyed to the nip formed between the intermediate transfer belt 42 and the film 900. The toner 501 of the lowermost toner layer is likely to scatter because the adhesive force between toner particles of the toner 501 is relatively weak, and thus, the end portion of the toner layer adheres onto the film 900 outside the pattern. The scattered toner 501 adheres to the film 900 and is conveyed together with the film 900, and the specific multilayer toner image on the intermediate transfer belt 42 is conveyed by the rotation of the intermediate transfer belt 42. As a result, the scattered toner 501 is secondarily transferred to the film 900 together with the specific multilayer toner image at the nip formed between the intermediate transfer belt 42 and the film 900, thereby affecting the image to be formed on the film 900.

### (Mechanism for Preventing Influence on Image Due to Scattering of Toner of Lowermost Toner Layer by Specific Control)

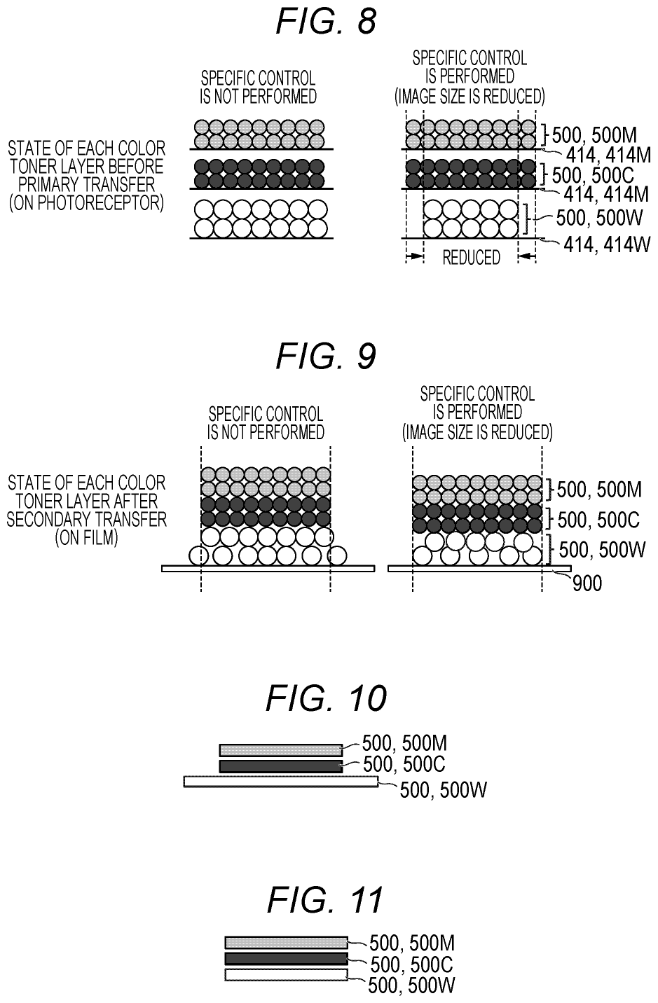

FIG. 8 is an explanatory diagram illustrating the states of the toner layers 500 of the respective colors on the photosensitive drums 414 before the primary transfer in order to compare a comparative example in which the specific control is not performed and the present embodiment in which the specific control is performed. FIG. 9 is an explanatory diagram illustrating the states of the toner layers 500 of the respective colors on the film 900 after the secondary transfer in order to compare the comparative example in which the specific control is not performed and the present embodiment in which the specific control is performed.

As illustrated in FIG. 8, in the present embodiment, the specific control is performed by exposure with an image signal in which the area of the lowermost toner layer of the specific multilayer toner image to be transferred onto the film 900 is reduced by a predetermined number of pixels relative to the area of the upper toner layer. As a result, after the development, the area of the white (W) toner layer 500W, which is the lowermost toner layer, on the photosensitive drum 414W becomes smaller than the areas of the magenta (M) and cyan (C) toner layers, which are the upper layers, on the photosensitive drum 414.

As illustrated in FIG. 9, in the present embodiment, the area of the white (W) toner layer 500W as the lowermost toner layer on the photosensitive drum 414W is reduced. Therefore, even when the lowermost toner layer is scattered to the outside of the pattern of the lowermost toner layer, it is possible to prevent the lowermost toner layer from being scattered to the outside of the pattern of the upper toner layer 500. On the other hand, in the comparative example in which the specific control is not performed, the lowermost toner layer may scatter to the outside of the pattern of the lowermost toner layer, and thus may scatter to the outside of the pattern of the upper toner layer 500.

Therefore, by the specific control, the influence on the image to be formed on the film 900 due to the scattering of the toner of the lowermost toner layer can be reduced.

As described above, in the present embodiment, when the specific multilayer toner image is formed, the area of the lowermost toner layer of the specific multilayer toner image to be transferred onto the film 900 is reduced. On the other hand, when a multilayer toner image other than the specific multilayer toner image is formed, the specific control is not performed.

FIG. 10 is an explanatory diagram illustrating a multilayer toner image other than the specific multilayer toner image. FIG. 11 is an explanatory diagram illustrating a specific multilayer toner image. FIGS. 10 and 11 illustrate a multilayer toner image other than the specific multilayer toner image and the specific multilayer toner image, respectively, which are formed on the film 900. Note that for the convenience of describing the difference between the multilayer toner image other than the specific multilayer toner image and the specific multilayer toner image, the specific multilayer toner image illustrated in FIG. 11 is illustrated as a specific multilayer toner image formed on the film 900 when the specific control is not performed.

The multilayer toner image 510 other than the specific multilayer toner image is a multilayer toner image 510 in which the toner layers 500 of the respective colors do not have the same pattern. FIG. 10 illustrates a multilayer toner image 510 in which only the pattern of a white (W) toner layer 500W, which is the lowermost toner image, is larger than the areas of cyan (C) and magenta (M) toner layers 500, which are the upper toner layers 500. The multilayer toner image 510 illustrated in FIG. 10 is included in the multilayer toner image other than the specific multilayer toner image. The multilayer toner image 510 other than the specific multilayer toner image includes, for example, a multilayer toner image 510 for forming an image of a black barcode on a white background.

The specific multilayer toner image is a multilayer toner image 510 in which the toner layers 500 of the respective colors have the same pattern. FIG. 11 illustrates a specific multilayer toner image in which a white (W) toner layer, which is the lowermost toner image, and cyan (C) and magenta (M) toner layers 500, which are the upper toner layers 500, have the same pattern.

The reason why the specific control is not performed for the formation of the multilayer toner image 510 other than the specific multilayer toner image is as follows. For example, even if the toner layer 500W of white (W) that is the color of a white background scatters during the formation of an image of a black barcode on the white background, the influence caused by the scattering of the toner layer 500W is hardly visible, although the size of the white background merely increases slightly. By not performing the specific control during the formation of the multilayer toner image 510 other than the specific multilayer toner image, the calculation amount of the controller 110 and the image controller 160 can be reduced.

(Relationship Between Type of Recording Medium and Amount of Reduction in Area of Lowermost Toner Layer of Specific Multilayer Toner Image to be Transferred onto Recording Medium by Specific Control)
1. Case where Recording Medium is Film Made of PP, PET, Etc.

When the recording medium is the film 900 made of PP, PET, or the like, the amount of reduction in the area of the lowermost toner layer of the specific multilayer toner image to be transferred to the recording medium can be relatively increased. The reason is as follows. The film 900 has a high electrical resistance and is easily charged, and thus the toner 501 of the lowermost toner layer is likely to scatter on the recording medium immediately before the nip where the secondary transfer is performed. In the case where the recording medium is a film made of PP, PET, etc., the area of the lowermost toner layer of the specific multilayer toner image to be transferred onto the recording medium is reduced by 7 dot in terms of the number of pixels when the pixel density is, for example, 1200 dpi.

2. Case where Recording Medium is Plain Paper or Coated Paper

When the recording medium is plain paper or coated paper, the amount of reduction in the area of the lowermost toner layer of the specific multilayer toner image to be transferred to the recording medium can be relatively decreased. The reason is as follows. The plain paper or coated paper has a low electrical resistance and is less likely to be charged, and thus the toner 501 of the lowermost toner layer is less likely to scatter on the recording medium immediately before the nip where the secondary transfer is performed. In the case where the recording medium is plain paper or coated paper, the area of the lowermost toner layer of the specific multilayer toner image to be transferred onto the recording medium is reduced by 3 dot in terms of the number of pixels when the pixel density is, for example, 1200 dpi.

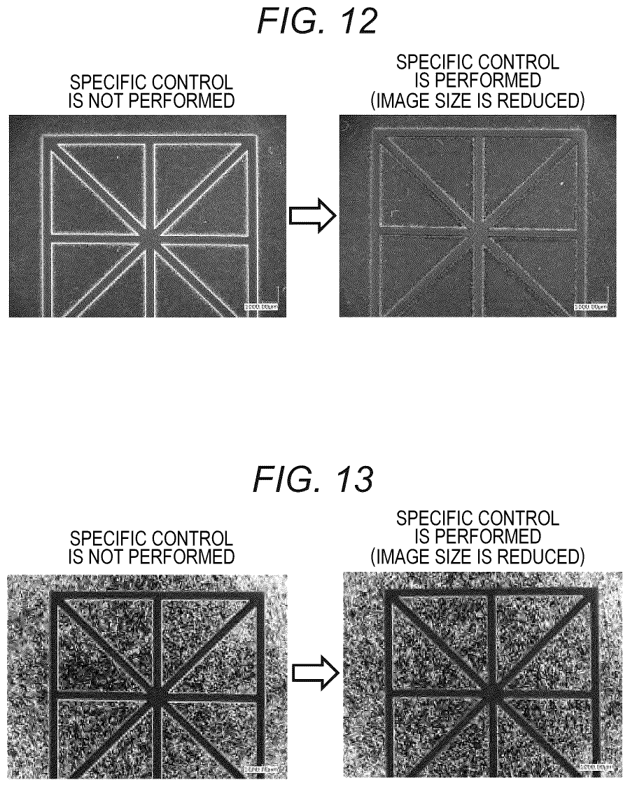

FIG. 12 is a diagram illustrating, for comparison, a photograph of a comparative example in which a specific multilayer toner image is formed on a tack sheet without the specific control and a photograph of an example in which the specific multilayer toner image is formed on a tack sheet with the specific control.

The example illustrated in FIG. 12 uses a tack sheet that has a surface base material formed from transparent PP and a release paper formed from transparent PET. The lowermost toner image of the specific multilayer toner image is formed with white (W) toner, and the toner layer 500 with cyan (C) toner having the same pattern as the lowermost toner image is superimposed on the lowermost toner image. In the print data commonly used in the example and the comparative example, the lowermost toner image and the upper toner layer 500 have patterns of straight lines having a line width of 0.5 mm. In the example, an image is formed on the tack sheet based on image data in which the line width of the lowermost toner image is reduced by 0.14 mm as a result of the specific control.

In the comparative example, due to the scattering of the toner of the lowermost toner layer, an image in which the upper cyan (C) pattern is edged with the scattered white (W) toner is formed as illustrated in FIG. 12. In the example, such an influence on the image due to the scattering of the toner of the lowermost toner layer, which is seen in the comparative example, is reduced.

FIG. 13 is a diagram illustrating, for comparison, a photograph of a comparative example in which a specific multilayer toner image is formed on a foil sheet without the specific control and a photograph of an example in which the specific multilayer toner image is formed on a foil sheet with the specific control.

The example illustrated in FIG. 13 uses a foil sheet having a surface coated with silver. The lowermost toner image of the specific multilayer toner image is formed with white (W) toner, and the toner layer 500 with cyan (C) toner having the same pattern as the lowermost toner image is superimposed on the lowermost toner image. In the print data commonly used in the example and the comparative example, the lowermost toner image and the upper toner layer 500 have patterns of straight lines having a line width of 0.5 mm. In the example, an image is formed on the foil sheet based on image data in which the line width of the lowermost toner image is reduced by 0.06 mm as a result of the specific control.

In the comparative example, due to the scattering of the toner of the lowermost toner layer, an image in which the upper cyan (C) pattern is edged with the scattered white (W) toner is formed as illustrated in FIG. 13. In the example, such an influence on the image due to the scattering of the toner of the lowermost toner layer, which is seen in the comparative example, is reduced.

The controller 110 can change the reduction amount of the volume of the lowermost toner layer of the specific multilayer toner image during the specific control depending on the type of the recording medium on which the image is to be formed. The controller 110 can obtain the type of a recording medium on which an image is to be formed by reading print settings of print data. The controller 110 may acquire the type of a recording medium on which an image is to be formed from the detection result by a medium sensor. The controller 110 may acquire the type of a recording medium on which an image is to be formed as setting information input to the operation display unit 140. In a case where the recording medium is the film 900, the controller 110 reduces the area of the lowermost toner layer of the specific multilayer toner image to be transferred onto the recording medium by 7 dot in terms of the number of pixels. In a case where the recording medium is plain paper or coated paper, the controller 110 reduces the area of the lowermost toner layer of the specific multilayer toner image to be transferred onto the recording medium by 3 dot in terms of the number of pixels. These amounts of reduction can be stored in advance in the storage 120 in association with the type of recording medium. The number of pixels to be reduced may be directly input to the operation display 140 regardless of the type of a recording medium.

### (Characteristics of Lowermost Toner Layer of Specific Multilayer Toner Image)

### 1. Particle Diameter of Toner of Lowermost Toner Layer of Specific Multilayer Toner Image

In a case where the particle diameter of the toner of the lowermost toner layer of the specific multilayer toner image is larger than the particle diameter of the toner of the upper toner layer by 1 μm or more, the effect of reducing the influence on an image to be formed due to the scattering of the toner of the lowermost toner layer by the specific control increases. This is for the following reasons. Toner having a relatively large particle diameter has a small adhesion area between toner particles per unit volume, and thus the adhesive force between toner particles is also low. Therefore, when the lowermost toner layer is transferred on the intermediate transfer belt 42 in a superimposed manner with another toner layer during the primary transfer, the toner of the lowermost toner layer is likely to scatter on the intermediate transfer belt 42. Another reason is that, when the specific multilayer toner image is transferred onto the film 900 during the secondary transfer, the toner of the lowermost toner layer is likely to scatter onto the film 900 immediately before the specific multilayer toner image is conveyed to the nip formed between the intermediate transfer belt 42 and the film 900.

### 2. Circularity of Toner of Lowermost Toner Layer of Specific Multilayer Toner Image

In a case where the circularity of the toner of the lowermost toner layer of the specific multilayer toner image is smaller than the circularity of the toner of the upper toner layer by 2% or more, the effect of reducing the influence on an image to be formed due to the scattering of the toner of the lowermost toner layer by the specific control increases. This is for the following reasons. Toner having a relatively small circularity also has low adhesive force between toner particles. Therefore, when the lowermost toner layer is transferred on the intermediate transfer belt 42 in a superimposed manner with another toner layer during the primary transfer, the toner 501 of the lowermost toner layer is likely to scatter on the intermediate transfer belt 42. Another reason is that, when the specific multilayer toner image is transferred onto the film 900 during the secondary transfer, the toner 501 of the lowermost toner layer is likely to scatter onto the film 900 immediately before the specific multilayer toner image is conveyed to the nip formed between the intermediate transfer belt 42 and the film 900.

### 3. Specific Gravity of Toner of Lowermost Toner Layer of Specific Multilayer Toner Image

In a case where the specific gravity of the toner 501 of the lowermost toner layer of the specific multilayer toner image is 1.3 times or more the specific gravity of the toner 501 of the upper toner layer, the effect of reducing the influence on an image to be formed due to the scattering of the toner of the lowermost toner layer by the specific control increases. This is for the following reasons. Toner having a relatively large specific gravity has a small charge per unit weight. The toner 501 of the lowermost toner layer is bound to the intermediate transfer belt 42 by a transfer charge in a superimposed manner with the toner 501 of the other toner layer 500 on the intermediate transfer belt 42. However, the binding force is small, because the toner 501 having a relatively large specific gravity has a small charge. Therefore, when the lowermost toner layer is transferred on the intermediate transfer belt 42 in a superimposed manner with the other toner layer during the primary transfer, the toner 501 of the lowermost toner layer is likely to scatter on the intermediate transfer belt 42. Another reason is that, when the specific multilayer toner image is transferred onto the film 900 during the secondary transfer, the toner 501 of the lowermost toner layer is likely to scatter onto the film 900 immediately before the specific multilayer toner image is conveyed to the nip formed between the intermediate transfer belt 42 and the film 900.

### 4. Q/M of Toner of Lowermost Toner Layer of Specific Multilayer Toner Image

In a case where the average Q/M of the toner of the lowermost toner layer of the specific multilayer toner image is 0.8 times or less the Q/M of the toner of the upper toner layer, the effect of reducing the influence on an image to be formed due to the scattering of the toner 501 of the lowermost toner layer by the specific control increases. The Q/M is a ratio of a charge amount to a mass. This is for the following reasons. The toner 501 having a relatively small Q/M has a small charge per unit mass. The toner 501 of the lowermost toner layer is bound to the intermediate transfer belt 42 by a transfer charge in a superimposed manner with the toner 501 of the other toner layer 500 on the intermediate transfer belt 42. However, the binding force is small, because the toner 501 having a relatively small Q/M has a small charge. Therefore, when the lowermost toner layer is transferred on the intermediate transfer belt 42 in a superimposed manner with the other toner layer during the primary transfer, the toner 501 of the lowermost toner layer is likely to scatter on the intermediate transfer belt 42. Another reason is that, when the specific multilayer toner image is transferred onto the film 900 during the secondary transfer, the toner 501 of the lowermost toner layer is likely to scatter onto the film 900 immediately before the specific multilayer toner image is conveyed to the nip formed between the intermediate transfer belt 42 and the film 900.

### 5. Characteristics Due to Method for Manufacturing Toner of Lowermost Toner Layer of Specific Multilayer Toner Image

In a case where the toner of the lowermost toner layer of the specific multilayer toner image is manufactured by a pulverization method and the toner of the upper toner layer is manufactured by a polymerization method, the effect of reducing the influence on an image to be formed due to the scattering of the toner 501 of the lowermost toner layer by the specific control increases. This is for the following reasons. The toner 501 manufactured by the pulverization method has a small circularity. The toner 501 having a relatively small circularity also has low adhesive force between toner particles of the toner 501. Therefore, when the lowermost toner layer is transferred on the intermediate transfer belt 42 in a superimposed manner with another toner layer 500 during the primary transfer, the toner 501 of the lowermost toner layer is likely to scatter on the intermediate transfer belt 42. Another reason is that, when the specific multilayer toner image is transferred onto the film 900 during the secondary transfer, the toner 501 of the lowermost toner layer is likely to scatter onto the film 900 immediately before the specific multilayer toner image is conveyed to the nip formed between the intermediate transfer belt 42 and the film 900.

### 6. Color of Toner of Lowermost Toner Layer of Specific Multilayer Toner Image

In a case where the toner of the lowermost toner layer of the specific multilayer toner image has a spot color other than yellow (Y), magenta (M), cyan (C), and black (K), the effect of reducing the influence on an image to be formed due to the scattering of the toner of the lowermost toner layer by the specific control increases. This is for the following reasons. Toner of a spot color such as white (W) is required to have characteristics, such as light-shielding properties, different from those of toners of the respective colors of yellow (Y), magenta (M), cyan (C), and black (K). Therefore, the toner 501 of the lowermost toner layer often has the physical properties described in the sections 1 to 5 described above.

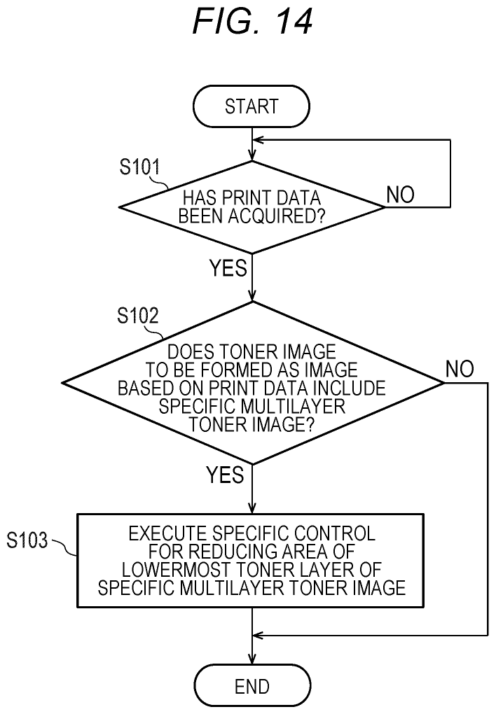

FIG. 14 is a flowchart illustrating an operation of the image forming apparatus 100. This flowchart can be executed by the controller 110 in accordance with a program.

The controller 110 determines whether or not print data has been acquired (S101). When determining that the print data has not been acquired (NO in step S101), the controller 110 executes the process of step S101 again.

When determining that the print date has been acquired (YES in S101), the controller 110 determines whether or not a toner layer 510 to be formed on the film 900 as an image based on the print data includes a specific multilayer toner image (S102). When determining that the toner image 510 to be formed on the film 900 as an image based on the print data does not include a specific multilayer toner image (NO in S102), the controller 110 does not perform the specific control.

When determining that the toner image 510 to be formed on the film 900 as an image based on the print data includes a specific multilayer toner image (YES in S102), the controller 110 executes the specific control for reducing the area of the lowermost toner layer of the specific multilayer toner image (S103).

### Second Embodiment

A second embodiment will be described. The present embodiment is different from the first embodiment in the following points. In the first embodiment, the specific control is performed by causing the image controller 160 to generate an image signal in which the area of the lowermost toner layer of the specific multilayer toner image to be transferred onto the film 900 is reduced by a predetermined number of pixels relative to the area of the upper toner layer 500. On the other hand, the present embodiment performs specific control by reducing the light amount of a laser of an optical writer 413 that forms an electrostatic latent image for forming the lowermost toner layer of a specific multilayer toner image to be transferred onto a film 900. In other respects, the present embodiment is the same as the first embodiment, and therefore the redundant description will be omitted or simplified.

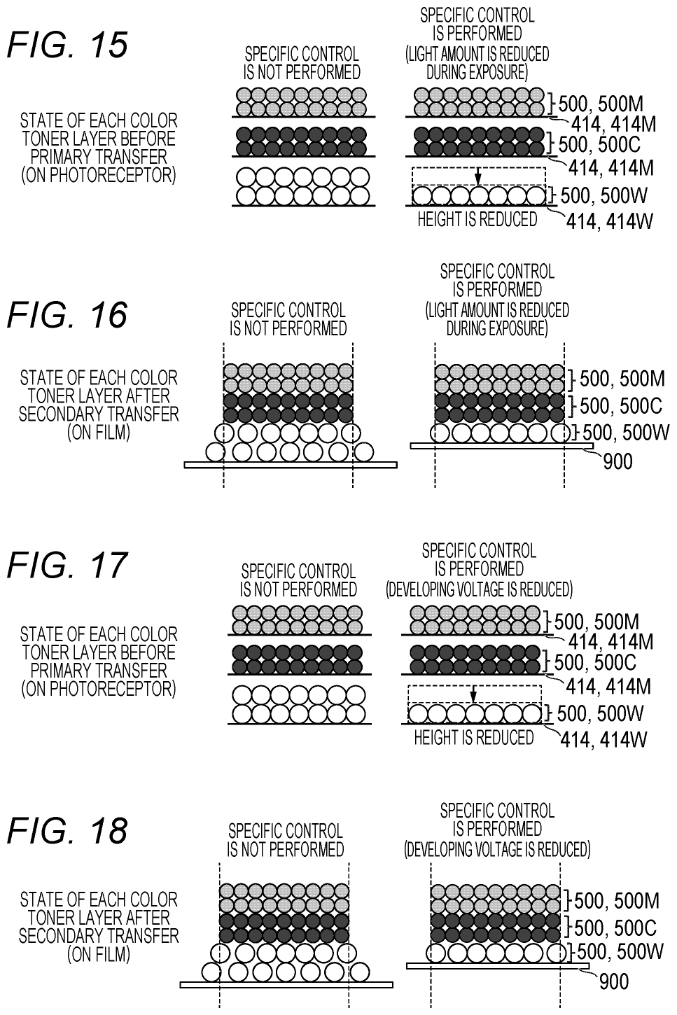

FIG. 15 is an explanatory diagram illustrating states of toner layers 500 of the respective colors on photosensitive drums 414 before the primary transfer in order to compare a comparative example in which the specific control is not performed and the present embodiment in which the specific control is performed. FIG. 16 is an explanatory diagram illustrating states of the toner layers 500 of the respective colors on the film 900 after the secondary transfer in order to compare the comparative example in which the specific control is not performed and the present embodiment in which the specific control is performed.

In the present embodiment, the controller 110 performs the specific control by reducing the light amount of a laser of the optical writer 413 that forms an electrostatic latent image for forming the lowermost toner layer of the specific multilayer toner image to be transferred onto the film 900 as illustrated in FIG. 15. The amount of laser light is reduced to, for example, 70 to 50% of the amount of laser light set at the time of starting the image forming apparatus 100. As a result, after the development, the volume of the white (W) toner layer 500W as the lowermost toner layer on the photosensitive drum 414W becomes smaller than the volume of a single-layer toner image to be transferred onto the film 900 when the single-layer toner image having a pattern same as that of the lowermost toner layer is formed. Such specific control enables reduction in the height of the white (W) toner layer 500W which is the lowermost toner layer after the development, for example.

In the present embodiment, the volume of the white (W) toner layer 500W which is the lowermost toner layer on the photosensitive drum 414W is reduced. Therefore, as illustrated in FIG. 16, it is possible to reduce the amount of scattering of the lowermost toner layer to the outside of the pattern of the lowermost toner layer during the primary transfer and the secondary transfer. On the other hand, in the comparative example in which the specific control is not performed, the lowermost toner layer may scatter to the outside of the pattern of the lowermost toner layer, and thus may scatter to the outside of the pattern of the upper toner layer 500.

Therefore, by the specific control, the influence on an image to be formed on the film 900 due to the scattering of the toner of the lowermost toner layer can be reduced.

### Third Embodiment

A third embodiment will be described. The present embodiment is different from the first embodiment in the following points. In the first embodiment, the specific control is performed by causing the image controller 160 to generate an image signal in which the area of the lowermost toner layer of the specific multilayer toner image to be transferred onto the film 900 is reduced by a predetermined number of pixels relative to the area of the upper toner layer 500. On the other hand, the present embodiment performs specific control by decreasing a developing voltage of a developing device 411 upon developing the lowermost toner layer of a specific multilayer toner image to be transferred onto a film 900. In other respects, the present embodiment is the same as the first embodiment, and therefore the redundant description will be omitted or simplified.

FIG. 17 is an explanatory diagram illustrating states of toner layers 500 of the respective colors on photosensitive drums 414 before the primary transfer in order to compare a comparative example in which the specific control is not performed and the present embodiment in which the specific control is performed. FIG. 18 is an explanatory diagram illustrating states of the toner layers 500 of the respective colors on the film 900 after the secondary transfer in order to compare the comparative example in which the specific control is not performed and the present embodiment in which the specific control is performed.

In the present embodiment, the controller 110 performs the specific control by decreasing a developing voltage of the developing device 411 upon developing the lowermost toner layer of the specific multilayer toner image to be transferred onto the film 900 as illustrated in FIG. 17. The developing voltage is reduced to, for example, 70 to 50% of the developing voltage set at the time of starting the image forming apparatus 100. As a result, after the development, the volume of the white (W) toner layer 500W as the lowermost toner layer on the photosensitive drum 414W becomes smaller than the volume of a single-layer toner image to be transferred onto the film 900 when the single-layer toner image having a pattern same as that of the lowermost toner layer is formed. Such specific control enables reduction in the height of the white (W) toner layer 500W which is the lowermost toner layer after the development, for example.

In the present embodiment, the volume of the white (W) toner layer 500W which is the lowermost toner layer on the photosensitive drum 414W is reduced. Therefore, as illustrated in FIG. 18, it is possible to reduce the amount of scattering of the lowermost toner layer to the outside of the pattern of the lowermost toner layer during the primary transfer and the secondary transfer. On the other hand, in the comparative example in which the specific control is not performed, the lowermost toner layer may scatter to the outside of the pattern of the lowermost toner layer, and thus may scatter to the outside of the pattern of the upper toner layer 500.

Therefore, by the specific control, the influence on an image to be formed on the film 900 due to the scattering of the toner of the lowermost toner layer can be reduced.

### Fourth Embodiment

A fourth embodiment will be described. The present embodiment is different from the first embodiment in the following points. In the first embodiment, the specific control is performed by causing the image controller 160 to generate an image signal in which the area of the lowermost toner layer of the specific multilayer toner image to be transferred onto the film 900 is reduced by a predetermined number of pixels relative to the area of the upper toner layer 500. On the other hand, the present embodiment performs specific control by changing a primary transfer voltage of a primary transfer roller 415 upon transferring, onto an intermediate transfer belt 42, a specific multilayer toner image to be transferred onto a film 900. In other respects, the present embodiment is the same as the first embodiment, and therefore the redundant description will be omitted or simplified.

The controller 110 performs the specific control by changing a primary transfer voltage of the primary transfer roller 415 upon transferring, onto the intermediate transfer belt 42, a specific multilayer toner image to be transferred onto the film 900. The controller 110 changes the value of the primary transfer voltage from a preset value of the primary transfer voltage at the time of starting the image forming apparatus 100 in the specific control.

Whether to increase or decrease the primary transfer voltage in the specific control can be appropriately set according to the property of toner of a white (W) toner layer that is the lowermost toner layer. In a case where the particle diameter of toner of the lowermost toner layer is relatively large and the bonding force between particles of toner is relatively weak, the electrostatic force for attracting the toner of the lowermost toner layer to the intermediate transfer belt 42 is weakened by decreasing the primary transfer voltage, so that the toner tends to be less likely to scatter. Therefore, in this case, the specific control can be performed to reduce the primary transfer voltage. In a case where the Q/M of toner is small, the binding force of toner of the lowermost toner layer on the intermediate transfer belt 42 is increased by increasing the primary transfer voltage, so that the toner is less likely to scatter in some cases. Therefore, in this case, the specific control for increasing the primary transfer voltage can be performed. In the specific control, the primary transfer voltage may be changed by ±30% from a preset value.

### Fifth Embodiment

A fifth embodiment will be described. The present embodiment is different from the first embodiment in the following points. In the first embodiment, the specific control is performed by causing the image controller 160 to generate an image signal in which the area of the lowermost toner layer of the specific multilayer toner image to be transferred onto the film 900 is reduced by a predetermined number of pixels relative to the area of the upper toner layer 500. On the other hand, the present embodiment performs specific control by changing a secondary transfer voltage of a secondary transfer roller 43 upon transferring, from an intermediate transfer belt 42 to a film 900, a specific multilayer toner image to be transferred onto the film 900. In other respects, the present embodiment is the same as the first embodiment, and therefore the redundant description will be omitted or simplified.

The controller 110 performs the specific control by changing a secondary transfer voltage of the secondary transfer roller 43 upon transferring, from the intermediate transfer belt 42 to the film 900, a specific multilayer toner image to be transferred onto the film 900. The controller 110 changes the value of the secondary transfer voltage from a preset value of the secondary transfer voltage at the time of starting the image forming apparatus 100 in the specific control.

Whether to increase or decrease the secondary transfer voltage in the specific control can be appropriately set according to a relationship between the secondary transfer voltage and the degree of scattering of toner of a white (W) toner layer that is the lowermost toner layer. For example, reducing the secondary transfer voltage weakens an electric field on the near side in the conveyance direction of the film 900 at the nip formed between the intermediate transfer belt 42 and the film 900 during the secondary transfer. For this reason, the force of attracting the toner 501 of the white (W) toner layer, which is the lowermost toner layer, from the intermediate transfer belt 42 by the electric field is weakened, and thus the toner 501 can be less likely to scatter. On the other hand, when the secondary transfer voltage is too low, the binding force of the toner 501 by the film 900 on the film 900 passing through the nip is weakened, and the toner may scatter on the film 900 after passing through the nip. For example, in a case where the film 900 is made of PP material and has a thickness of 100 μm, the secondary transfer voltage may be changed by ±20% from a preset value in the specific control.

### (Relationship Between Pattern of Specific Multilayer Toner Image and Specific Control in First to Fifth Embodiments)

1. Case where Pattern of Specific Multilayer Toner Image is Thin Line or Thin Character

In this case, it is preferable to perform the specific control according to the second to fifth embodiments. The reason is as follows. When the specific control according to the first embodiment is performed in this case, the white (W) toner layer which is the lowermost toner layer may disappear by the specific control.

2. Case where Pattern of Specific Multilayer Toner Image is Large or Pattern of Specific Multilayer Toner Image is Thick Line or Thick Character

In this case, it is preferable to perform the specific control according to the first embodiment. The reason is as follows. When the specific control according to the second to fourth embodiments is performed in this case, an image to be formed may be affected as follows. There is a possibility that the deposited amount of toner 501 of the white (W) toner layer, which is the lowermost toner layer, on the film 900 decreases, so that the contrast ratio by the toner 501 decreases, and thus the color tone of the specific multilayer toner image changes. In addition, when the specific control according to the fifth embodiment is performed, the transferability from the intermediate transfer belt 42 to the film 900 is deteriorated by reducing the secondary transfer voltage, which may lead to a reduction in image density of the specific multilayer toner image.

The embodiments have the following effects.

The specific control is performed for reducing, relative to the volume of a toner image that includes a single toner layer of a single color and that is to be transferred onto a recording medium, the volume of the lowermost toner layer with a color same as that of the single toner layer in a multilayer toner image to be transferred onto the recording medium, the multilayer toner image being formed by superimposing toner layers of a plurality of colors of the same pattern as the single toner layer. Thus, the influence on an image to be formed due to the scattering of toner of the lowermost toner layer of the multilayer toner image to be transferred onto the recording medium can be reduced.

Further, an image signal is generated in which the area of the lowermost toner layer of the multilayer toner image to be transferred onto the recording medium is reduced by a predetermined number of pixels relative to the area of the upper toner layer, and the toner image is formed on the basis of the generated image signal. Thus, the influence on an image to be formed due to the scattering of toner of the lowermost toner layer of the multilayer toner image to be transferred onto the recording medium can be simply and effectively reduced.

In addition, the specific control is performed for reducing the light amount of a laser that forms an electrostatic latent image for forming the lowermost toner layer of the specific multilayer toner image to be transferred onto the recording medium. Thus, the influence on an image to be formed due to the scattering of toner of the lowermost toner layer of the multilayer toner image to be transferred onto the recording medium can be simply and effectively reduced.

In addition, the specific control is performed for decreasing a developing voltage upon developing the lowermost toner layer of the specific multilayer toner image to be transferred onto the recording medium. Thus, the influence on an image to be formed due to the scattering of toner of the lowermost toner layer of the multilayer toner image to be transferred onto the recording medium can be simply and effectively reduced.

In addition, the specific control is performed for changing a primary transfer bias upon transferring, onto the intermediate transfer member, the lowermost toner layer of the specific multilayer toner image to be transferred onto the recording medium. Thus, the influence on an image to be formed due to the scattering of toner of the lowermost toner layer of the multilayer toner image to be transferred onto the recording medium can be simply and effectively reduced.

In addition, the specific control is performed for changing the secondary transfer bias of the secondary transferer when the multilayer toner image is formed on the recording medium. Thus, the influence on an image to be formed due to the scattering of toner of the lowermost toner layer of the multilayer toner image to be transferred onto the recording medium can be simply and effectively reduced.

In addition, the reduction amount of the volume of the lowermost toner layer of the specific multilayer toner image during the specific control is changed depending on the acquired type of the recording medium. Thus, the influence on an image to be formed due to the scattering of toner of the lowermost toner layer of the multilayer toner image to be transferred onto the recording medium can be simply and effectively reduced.

Further, the specific control is performed when the particle diameter of the toner of the lowermost toner layer of the multilayer toner image is larger than the particle diameter of the toner of the upper toner layer by 1 μm or more. Thus, the effect of reducing, by the specific control, the influence on an image to be formed due to the scattering of toner of the lowermost toner layer of the multilayer toner image to be transferred onto the recording medium can be improved.

Further, the specific control is performed when the circularity of the toner of the lowermost toner layer of the multilayer toner image is smaller than the circularity of the toner of the upper toner layer by 2% or more. Thus, the effect of reducing, by the specific control, the influence on an image to be formed due to the scattering of toner of the lowermost toner layer of the multilayer toner image to be transferred onto the recording medium can be improved.

Further, the specific control is performed when the specific gravity of the toner of the lowermost toner layer of the multilayer toner image is 1.3 times or more the specific gravity of the toner of the upper toner layer. Thus, the effect of reducing, by the specific control, the influence on an image to be formed due to the scattering of toner of the lowermost toner layer of the multilayer toner image to be transferred onto the recording medium can be improved.

Further, the specific control is performed when the average Q/M of the toner of the lowermost toner layer of the multilayer toner image is 0.8 times or less the average Q/M of the toner of the upper toner layer. Thus, the effect of reducing, by the specific control, the influence on an image to be formed due to the scattering of toner of the lowermost toner layer of the multilayer toner image to be transferred onto the recording medium can be improved.

Further, the specific control is performed when the toner of the lowermost toner layer of the multilayer toner image is manufactured by a pulverization method and the toner of the upper toner layer is manufactured by a polymerization method. Thus, the effect of reducing, by the specific control, the influence on an image to be formed due to the scattering of toner of the lowermost toner layer of the multilayer toner image to be transferred onto the recording medium can be improved.

In addition, the specific control is performed when the color of toner of the toner layers other than the lowermost layer of the multilayer toner image is yellow, magenta, cyan, or black, and the toner of the toner layer of the lowermost layer has a color other than yellow, magenta, cyan, and black. Thus, the effect of reducing, by the specific control, the influence on an image to be formed due to the scattering of toner of the lowermost toner layer of the multilayer toner image to be transferred onto the recording medium can be improved.

The present invention is not limited to the above-described embodiments.

For example, in the embodiments, the specific multilayer toner image is formed by superimposing toner layers of magenta (M), cyan (C), and white (W). However, the specific multilayer toner image may be formed by superimposing toner of a color other than magenta (M) and cyan (C) on the white (W) toner layer. The specific multilayer toner image may be formed by superimposing magenta (M) toner and/or cyan (C) toner and toner of a color other than magenta (M) and cyan (C) on a white (W) toner layer.

Further, the color of the lowermost toner layer of the specific multilayer toner image may be a spot color other than white (W) such as gold or silver.

While the embodiments of the present invention have been described and illustrated in detail, the disclosed embodiments have been created for purposes of illustration and example only, and not limitation. The scope of the invention is to be interpreted by the wording of the appended claims.

What is claimed is:

1. An image forming apparatus that forms a toner image by superimposing toner layers on an intermediate transfer member and transfers the formed toner image onto a recording medium, the image forming apparatus comprising a hardware processor that performs specific control for reducing, relative to a volume of a single-layer toner image to be transferred onto the recording medium when the single-layer toner image including a single-color toner layer is formed, a volume of a lowermost toner layer with a color same as a color of the single-color toner layer in a multilayer toner image to be transferred onto the recording medium when the multilayer toner image is formed by superimposing toner layers of a plurality of colors having a pattern same as a pattern of the single-layer toner image.

2. The image forming apparatus according to claim 1, further comprising:
an image signal generator that generates an image signal based on print data; and
a toner image former that forms the toner image based on the image signal, wherein
the hardware processor performs the specific control by causing the image signal generator to generate the image signal in which an area of the lowermost toner layer of the multilayer toner image to be transferred onto the recording medium is reduced by a predetermined number of pixels from an area of an upper toner layer.

3. The image forming apparatus according to claim 1, further comprising:
a photoreceptor;
a charger that uniformly charges the photoreceptor;
a writing section that forms an electrostatic latent image on the photoreceptor using a laser; and
a developing section that develops the electrostatic latent image formed on the photoreceptor with toner, wherein
the hardware processor performs the specific control by reducing a light amount of the laser that forms the electrostatic latent image for forming the lowermost toner layer of the multilayer toner image to be transferred onto the recording medium.

4. The image forming apparatus according to claim 1, further comprising:
a photoreceptor;
a charger that uniformly charges the photoreceptor;
a writing section that forms an electrostatic latent image on the photoreceptor using a laser; and
a developing section that develops the electrostatic latent image formed on the photoreceptor with toner, wherein
the hardware processor performs the specific control by reducing a developing voltage by the developing section upon developing the lowermost toner layer of the multilayer toner image to be transferred onto the recording medium.

5. The image forming apparatus according to claim 1, further comprising
a primary transferer that comes into contact with a photoreceptor via the intermediate transfer member and transfers the toner layers on the photoreceptor onto the intermediate transfer member, wherein
the hardware processor performs the specific control by changing a primary transfer bias of the primary transferer upon transferring, onto the intermediate transfer member, the lowermost toner layer of the multilayer toner image to be transferred onto the recording medium.

6. The image forming apparatus according to claim 1, further comprising
a secondary transferer that comes in contact with the intermediate transfer member via the recording medium and transfers the toner image on the intermediate transfer member onto the recording medium, wherein
the hardware processor performs the specific control by changing a secondary transfer bias of the secondary transferer upon forming the multilayer toner image on the recording medium.

7. The image forming apparatus according to claim 1, wherein the hardware processor changes a reduction amount of the volume of the lowermost toner layer of the multilayer toner image in the specific control depending on a type of the recording medium that has been acquired.

8. The image forming apparatus according to claim 1, wherein a particle diameter of toner of the lowermost toner layer of the multilayer toner image is larger than a particle diameter of toner of an upper toner layer by 1 μm or more.

9. The image forming apparatus according to claim 1, wherein a circularity of toner of the lowermost toner layer of the multilayer toner image is smaller than a circularity of toner of an upper toner layer by 2% or more.

10. The image forming apparatus according to claim 1, wherein a specific gravity of toner of the lowermost toner layer of the multilayer toner image is 1.3 times or more a specific gravity of toner of an upper toner layer.

11. The image forming apparatus according to claim 1, wherein an average Q/M of toner of the lowermost toner layer of the multilayer toner image is 0.8 times or less an average Q/M of toner of an upper toner layer.

12. The image forming apparatus according to claim 1, wherein toner of the lowermost toner layer of the multilayer toner image is manufactured by a pulverization method, and toner of an upper toner layer is manufactured by a polymerization method.

13. The image forming apparatus according to claim 1, wherein a color of toner of a toner layer other than the lowermost layer of the multilayer toner image is yellow, magenta, cyan, or black, and toner of the lowermost toner layer has a color other than yellow, magenta, cyan, and black.

14. A control method for controlling an image forming apparatus that forms a toner image by superimposing toner layers on an intermediate transfer member and transfers the formed toner image onto a recording medium, the control method comprising reducing, relative to a volume of a single-layer toner image to be transferred onto the recording medium when the single-layer toner image including a single-color toner layer is formed, a volume of a lowermost toner layer with a color same as a color of the single-color toner layer in a multilayer toner image to be transferred onto the recording medium when the multilayer toner image is formed by superimposing toner layers of a plurality of colors having a pattern same as a pattern of the single-layer toner image.

15. A non-transitory computer-readable recording medium storing a control program for an image forming apparatus that forms a toner image by superimposing toner layers on an intermediate transfer member and transfers the formed toner image onto a recording medium, the control program causing a computer to execute reducing, relative to a volume of a single-layer toner image to be transferred onto the recording medium when the single-layer toner image including a single-color toner layer is formed, a volume of a lowermost toner layer with a color same as a color of the single-color toner layer in a multilayer toner image to be transferred onto the recording medium when the multilayer toner image is formed by superimposing toner layers of a plurality of colors having a pattern same as a pattern of the single-layer toner image.
